(19) United States
(12) Patent Application Publication
(10) Pub. No.: US 2011/0024386 A1
(43) Pub. Date: Feb. 3, 2011

(54) ETCHING METHOD AND SUBSTRATE HAVING CONDUCTIVE POLYMER

(76) Inventors: Yasuo Nishimura, Kanagawa (JP); Takashi Ihara, Aichi (JP)

Correspondence Address: KRATZ, QUINTOS & HANSON, LLP, 1420 K Street, N.W., 4th Floor, WASHINGTON, DC, 20005, US

(21) Appl. No.: 12/933,968

(22) PCT Filed: Mar. 19, 2009
(86) PCT No.: PCT/JP2009/055402

§ 371 Date: Sep. 22, 2010

(30) Foreign Application Priority Data
Mar. 31, 2008 (JP) 2008-093379

(51) Int. Cl. C08J 7/00; H01B 13/00

(52) U.S. Cl. 216/13

(57) ABSTRACT

An object of the present invention is to provide an etching method that enables control of etching of a conductive polymer using a specific cerium (IV) compound to be carried out simply and easily, thus ensuring that etching is carried out stably, and to provide a substrate having a conductive polymer that has been etched by the etching method.

The etching method of the present invention includes an etching step of etching a conductive polymer using an etching liquid containing a specific cerium (IV) compound, an analysis step of analyzing the etching liquid by at least one analysis means selected from the group consisting of oxidation-reduction potential measurement, oxidation-reduction titration, and electrical conductivity measurement, and a control step of controlling the etching step according to the results obtained in the analysis step.

### TECHNICAL FIELD

The present invention relates to an etching method and a substrate having a conductive polymer.

### BACKGROUND ART

Currently, as a transparent conductive film, it is mainly ITO (indium tin oxide), which contains indium (In), that is used, but In is a rare element with recoverable reserves of 3,000 tons. It is predicted that the recoverable reserves might be exhausted as early as around 2011 to 2013, and alternative materials to ITO that do not employ In have been investigated. There have been remarkable improvements in the conductivity of conductive polymers, and conductive polymers are promising as alternative materials to ITO.

These conductive polymers have the characteristics of being electrically conductive, optically transmissive, luminescent, and flexible even after being made into a film; the application thereof to transparent conductive films, electrolytic capacitors, antistatic agents, batteries, organic EL elements, etc. has been investigated, and in some areas they are finding practical use.

By using a conductive polymer having high stability and higher conductivity than the electrolyte of an electrolytic capacitor, an electrolytic capacitor having improved frequency characteristics and excellent heat resistance can be formed.

Since static electricity can be prevented while maintaining transparency by forming a thin film of a conductive polymer on the surface of a polymer film, such a conductive polymer is used as an antistatic film or an antistatic container having good ease of use.

Conductive polymers can be used as the positive electrode of a rechargeable battery, and are used in a lithium polyaniline cell, a lithium ion polymer cell, etc.

Furthermore, there are polymer organic EL displays in which a conductive polymer is used as a light-emitting layer, and flexible displays can be formed by using plastic as a substrate instead of glass. Moreover, positive hole-transporting layers may employ a conductive polymer. Organic EL displays such as polymer organic EL displays have a wide viewing angle because they are self-luminous displays, can easily be made thin, and have excellent color reproduction. Furthermore, since luminescence is due to recombination of a positive hole and an electron, the response speed is high. As hereinbefore described, since organic EL displays have excellent features, they have future promise as displays.

Furthermore, electronic elements such as diodes and transistors may be formed by using a conductive polymer, and improvements in performance are being investigated. In order to develop a solar cell that is less expensive than the currently predominant solar cells employing silicon, the use of a conductive polymer instead of platinum as a counter electrode to titanium dioxide in a dye-sensitized solar cell has been investigated.

In this way, conductive polymers are useful materials for the electronics industry in the future, and a method for patterning a conductive polymer is an important technique when a conductive polymer is used.

There are several types of methods for patterning a conductive polymer. First, there is patterning employing a printing method such as inkjet (see e.g. Patent Publication 1). Since the printing method carries out patterning at the same time as film formation, the production process is simple, but it is necessary to make a conductive polymer into an ink. However, conductive polymers are prone to aggregation, and it is difficult to make them into an ink. Furthermore, it is necessary to prevent spreading after printing, and there is the problem that a peripheral area of a liquid droplet becomes thicker than a central area after the ink dries.

On the other hand, a photoetching method, which is widely used for patterning, carries out patterning after a uniform film is formed, and there is therefore an advantage that a simple film-forming method can be employed.

Furthermore, as a method for controlling an etching liquid in etching of a metal, for example, Patent Document 2 discloses an etching liquid control method in which, when a metal thin film substrate is subjected to etching using an etching liquid containing Ce⁴⁺ as an oxidizing agent, the Ce⁴⁺ concentration in the etching liquid is detected, and Ce⁴⁺ is additionally supplied so as to maintain (Ce⁴⁺ concentration)/(initial Ce⁴⁺ concentration) in a predetermined concentration range.

Moreover, Patent Document 3 discloses an etching liquid control method for maintaining the component concentration of an etching liquid for a metal-like material, which is used repeatedly, at a substantially constant level, the method comprising at least: a step of titrating the etching liquid by means of a solution exhibiting a property opposite to that of the etching liquid and, at the same time, measuring the electrical conductivity of the etching liquid by means of a conductivity meter; a computation step of calculating a component concentration of the etching liquid from a measurement value obtained in the measurement step and calculating the amount of an insufficient component in the etching liquid; and a replenishment step of replenishing the etching liquid with a component stock solution and/or replenisher for the amount of insufficient component obtained in the computation step.

Patent Publication 1: JP-A-2005-109435 (JP-A denotes a Japanese unexamined patent application publication)

### Patent Publication 2: JP-A-11-1781

### Patent Publication 3: JP-A-2004-437519

### DISCLOSURE OF INVENTION

### Problems to be Solved by the Invention

It is an object of the present invention to provide an etching method that enables control of etching of a conductive polymer using a specific cerium (IV) compound to be carried out simply and easily, thus ensuring that etching is carried out stably, and to provide a substrate having a conductive polymer that has been etched by the etching method.

### Means for Solving the Problems

As a result of an intensive investigation by the present inventors in order to solve the problems of the above-mentioned conventional techniques, it has been found for the first time that, as a result of examining in detail the relationship between amount etched and cerium (IV) concentration by oxidation-reduction titration using potassium iodide (KI) when a conductive polymer is subjected to etching using a specific cerium (IV) compound-containing etching liquid for a conductive polymer, there is a linear relationship. That is, it has been clarified that Ce⁴⁺ contained in the specific cerium (IV) compound-containing etching liquid for a conductive polymer oxidizes the conductive polymer, thus progressing etching, and it has been found that in an etching step control of the etching liquid can be carried out by an indicator for the amount of oxidation by cerium (IV), that is, oxidation-reduction titration and/or oxidation-reduction potential (ORP). When a metal, etc. is subjected to etching using a cerium compound, it is known that etching progresses by Ce⁴⁺ oxidizing the metal, but the mechanism of etching of a conductive polymer was not known.

Furthermore, from an examination of the relationship between amount etched, electrical conductivity, and absorbance, it has been found that the electrical conductivity decreases in proportion to the amount etched, and the absorbance changes.

As a result, it has been found that the above-mentioned objects can be achieved by <1> and <9> below, and the present invention has thus been accomplished. They are described together with <2> to <8>, which are preferred embodiments.

<1> An etching method comprising an etching step of etching a conductive polymer using an etching liquid comprising greater than 0.5 wt % but no greater than 70 wt % of (NH₄)₂Ce(NO₃)₆, at least 0.5 wt % but no greater than 30 wt % of Ce(SO₄)₂, or greater than 0.5 wt % but no greater than 30 wt % of (NH₄)₄Ce(SO₄)₄, an analysis step of analyzing the etching liquid by at least one analysis means selected from the group consisting of oxidation-reduction potential measurement, oxidation-reduction titration, and electrical conductivity measurement, and a control step of controlling the etching step according to the results obtained in the analysis step,
<2> the etching method according to <1> above, wherein in the analysis step analysis is carried out by at least oxidation-reduction potential measurement or oxidation-reduction titration,
<3> the etching method according to <1> or <2> above, wherein in the analysis step analysis is carried out by at least oxidation-reduction potential measurement,
<4> the etching method according to any one of <1> to <3> above, wherein in the control step the etching step is controlled by at least one control means selected from the group consisting of (1) means of replenishing with one or more types selected from (NH₄)₂Ce(NO₃)₆, Ce(SO₄)₂, and (NH₄)₄Ce(SO₄)₄, (2) means of replenishing with fresh etching liquid, (3) means of replacing with fresh etching liquid, and (4) means of regulating the etching time,
<5> the etching method according to any one of <1> to <4> above, wherein the conductive polymer is a polyacetylene, a polyparaphenylene, a polyparaphenylene vinylene, a polyphenylene, a polythienylene vinylene, a polyfluorene, a polyacene, a polyaniline, a polypyrrole, or a polythiophene,
<6> the etching method according to any one of <1> to <5> above, wherein the conductive polymer is a polyaniline, a polypyrrole, or a polythiophene,
<7> the etching method according to any one of <1> to <6> above, wherein the conductive polymer is poly(3,4-ethylenedioxythiophene),
<8> the etching method according to any one of <1> to <7> above, wherein the etching liquid comprises (NH₄)₂Ce(NO₃)₆, and
<9> a substrate having a conductive polymer that has been etched by the etching method according to any one of <1> to <8> above.

### EFFECTS OF THE INVENTION

In accordance with the present invention, there can be provided an etching method that enables control of etching of a conductive polymer using a specific cerium (IV) compound to be carried out simply and easily, thus ensuring that etching is carried out stably, and a substrate having a conductive polymer that has been etched by the etching method.

### BRIEF DESCRIPTION OF DRAWINGS

FIG. 1: One example of a schematic process diagram for obtaining a conductive polymer circuit pattern by etching a conductive polymer using an etching liquid.

FIG. 2: A diagram in which CAN concentration obtained by a titration method (oxidation-reduction titrimetry) using potassium iodide in Example 1 is plotted. The ordinate represents the CAN concentration (%) of an etching liquid, and the abscissa represents the amount (mg) of conductive polymer etched.

FIG. 3: A diagram in which CAN concentration obtained by a titration method (oxidation-reduction titrimetry) using potassium iodide in Example 2 is plotted. The ordinate represents the CAN concentration (%) of an etching liquid, and the abscissa represents the amount (mg) of conductive polymer etched.

FIG. 4: A diagram in which oxidation-reduction potential (ORP) measured in Example 4 is plotted over time (0 to 700 minutes). The ordinate represents the measurement value (mV) for ORP, and the abscissa represents time (min).

FIG. 5: A diagram in which oxidation-reduction potential (ORP) measured in Example 4 is plotted over time (600 to 2,000 minutes). The ordinate represents the measurement value (mV) for ORP, and the abscissa represents time (min).

### EXPLANATION OF REFERENCE NUMERALS AND SYMBOLS

A: A schematic diagram of a substrate on its own
B: A schematic diagram in which the substrate is equipped with a conductive polymer film
C: A schematic diagram in which the conductive polymer film has been coated with a resist
D: A schematic diagram in which the resist has been exposed in accordance with a circuit pattern
E: A schematic diagram in which the exposed resist has been removed
F: A schematic diagram after the conductive polymer film is etched
G: A schematic diagram in which a circuit diagram employing the conductive polymer has been completed by removing the resist
N1: 34 mg of conductive polymer added and stirring started.
N2: 108.8 mg of conductive polymer added.
N3: 164.2 mg of conductive polymer added.
N4: A total of 307 mg of conductive polymer added to etching liquid up to this point.
N5: 265.2 mg of conductive polymer added.
N6: A total of 572.2 mg of conductive polymer added to etching liquid up to this point.
N7: 20 mg of conductive polymer added.
1: Substrate
2: Conductive polymer film
3: Resist
4: Resist in exposed area

### BEST MODE FOR CARRYING OUT THE INVENTION

The present invention is explained in detail below. ‘%’ denotes ‘wt %’ unless otherwise specified.

### (Etching Method)

The etching method of the present invention comprises an etching step of etching a conductive polymer using an etching liquid comprising greater than 0.5 wt % but no greater than 70 wt % of (NH₄)₂Ce(NO₃)₆, at least 0.5 wt % but no greater than 30 wt % of Ce(SO₄)₂, or greater than 0.5 wt % but no greater than 30 wt % of (NH₄)₄Ce(SO₄)₄, an analysis step of analyzing the etching liquid by at least one analysis means selected from the group consisting of oxidation-reduction potential measurement, oxidation-reduction titration, and electrical conductivity measurement, and a control step of controlling the etching step according to the results obtained in the analysis step.

The etching method of the present invention is an etching method that etches a conductive polymer using a conductive polymer etching liquid comprising (NH₄)₂Ce(NO₃)₆, Ce(SO₄)₂, or (NH₄)₄Ce(SO₄)₄ and enables control of the etching step to be carried out simply and easily, thus enabling etching to be carried out stably.

### <Etching Step>

The etching method of the present invention comprises an etching step of etching a conductive polymer using an etching liquid comprising greater than 0.5 wt % but no greater than 70 wt % of (NH₄)₂Ce(NO₃)₆, at least 0.5 wt % but no greater than 30 wt % of Ce(SO₄)₂, or greater than 0.5 wt but no greater than 30 wt % of (NH₄)₄Ce(SO₄)₄ (hereinafter, also called a ‘specific etching liquid’).

The conductive polymer exhibits conductivity by π electron transfer. A large number of such conductive polymers have been reported.

Examples of conductive polymers that can be used in the present invention include polyaniline, polythiophene, polypyrrole, polyphenylene, polyfluorene, polybithiophene, polyisothiophene, poly(3,4-ethylenedioxythiophene), polyisothianaphthene, polyisonaphthothiophene, polyacetylene, polydiacetylene, poly(paraphenylene vinylene), polyacene, polythiazyl, poly(ethylene vinylene), polyparaphenylene, polydodecylthiophene, poly(phenylene vinylene), poly(thienylene vinylene), polyphenylenesulfide, and derivatives thereof. Among them, polythiophenes and polyanilines are preferable, polythiophenes are more preferable, and poly(3,4-ethylenedioxythiophene), which has excellent electroconductivity and excellent stability and heat resistance in air, is most preferable.

Furthermore, for the purpose of exhibiting higher electroconductivity when using a conductive polymer, a doping agent, called a dopant, may be used in combination. As the dopant used in the above-mentioned conductive polymer, a known dopant may be used, and depending on the type of conductive polymer, a halogen (bromine, iodine, chlorine, etc.), a Lewis acid (BF₃, PF_{S}, etc.), a protonic acid (HNO₃, H₂SO₄, etc.), a transition metal halide (FeCl₃, MoCl₅, etc.), an alkali metal (Li, Na, etc.), an organic material (amino acid, nucleic acid, surfactant, colorant, alkylammonium ion, chloranil, tetracyanoethylene (TCNE), 7,7,8,8-tetracyanoquinodimethane (TCNQ), etc.), etc. can be cited. A self-doping type conductive polymer, which is a conductive polymer itself having a doping effect, may be used. Furthermore, when a polythiophene is used as the conductive polymer, it is preferable to use polystyrenesulfonic acid as a dopant.

The conductivity of the conductive polymer that can be used in the present invention is not particularly limited as long as conductivity is exhibited, and it is preferably 10⁻⁶ to 10⁴ S/cm, more preferably 10⁻⁵⁵ to 10³ S/cm, and yet more preferably 10⁻⁵ to 5×10² S/cm. It is preferable for the conductivity of the conductive polymer used in the present invention to be in the above-mentioned range since it is suitable for patterning, etc. of a connected section.

Furthermore, in the present invention, the conductive polymer after film formation preferably has high transmittance in the visible light region when used. The transmittance is preferably 60% to 98% at a wavelength of 550 nm, more preferably 70% to 95%, and yet more preferably 80% to 93%. When the conductive polymer itself has a transmittance in the above-mentioned range, it may suitably be used in applications such as displays.

In the present invention, the visible light region is 400 to 700 nm. Measurement of transmittance may be carried out using a spectrophotometer.

Various types of conductive polymers are commercially available. A polyaniline marketed under the product name ‘Panipol’, manufactured by Panipol, is an organic solvent-soluble polyaniline doped with a functional sulfonic acid. A polyaniline marketed under the product name ‘Ormecon’, manufactured by Ormecon, is a solvent-dispersed polyaniline employing an organic acid as a dopant. A poly(3,4-ethylenedioxythiophene) marketed under the product name ‘Baytron’, manufactured by Bayer, employs polystyrenesulfonic acid as a dopant. In addition thereto, a polypyrrole marketed under the product name ‘ST Poly’, manufactured by Achilles Corporation, a sulfonated polyaniline marketed under the product name ‘PETMAX’, manufactured by Toyobo Co., Ltd., and a polyaniline marketed under the product name ‘SCS-NEO’, manufactured by Maruai Inc. may also be used in the present invention.

A conductive polymer described in Kagaku (Chemistry) 6 ‘Yukidoudensei Porima’ (Organic Conductive Polymers) 2001 of a patent licensing support chart as an enterprise for encouraging patent licensing may also be used in the present invention.

Examples of specific cerium (IV) compounds include (NH₄)₂Ce(NO₃)₆, Ce(SO₄)₂, Ce(NO₃)₄, and (NH₄)₄Ce(SO₄)₄, (NH₄)₂Ce(NO₃)₆, Ce(SO₄)₂, and (NH₄)₄Ce(SO₄)₄ are preferable, and (NH₄)₂Ce(NO₃)₆ and (NH₄)₄Ce(SO₄)₄ are more preferable. Furthermore, these cerium (IV) salts may be hydrates. In the present invention, it is preferable to use (NH₄)₂Ce(NO₃)₆ since a conductive polymer can be etched in a short period of time.

Furthermore, the etching liquid of the etching step may use in combination two or more types of specific cerium (IV) compounds selected from the group consisting of (NH₄)₂Ce(NO₃)₆, Ce(SO₄)₂, and (NH₄)₄Ce(SO₄)₄ as long as problems such as cloudiness do not occur, but it is preferable to use one type of specific cerium (IV) compound on its own. When two or more types of specific cerium (IV) compounds are used in combination, the concentration is determined for each specific cerium (IV) compound.

A solvent of the etching liquid comprising the specific cerium (IV) compound is not particularly limited as long as it can dissolve the cerium salt and does not interfere with the etching process, and water is preferable. It is also preferable to use a mixture of water and an inorganic acid as the solvent.

When (NH₄)₂Ce(NO₃)₆ is used in the present invention, the amount thereof added is greater than 0.5% from the viewpoint of the treatment capability of the etching liquid, and preferably at least 1.0%, and although the treatment speed increases as the concentration increases, from the viewpoint of solubility it is no greater than 70%, preferably no greater than 40%, more preferably 2.0% to 30% (in the present invention, ‘at least 2.0% but no greater than 30%’ is also expressed as ‘2.0% to 30%’, the same applies below), and yet more preferably 5.0% to 15%. It is preferable for the etching liquid employing (NH₄)₂Ce(NO₃)₆ of the present invention to have a concentration in the above-mentioned range since the etching capability is excellent.

In the etching liquid of the present invention employing (NH₄)₂Ce(NO₃)₆, in order to prevent decomposition of the etching liquid, a stabilizer may be used, and it is preferable for the etching liquid to comprise a stabilizer. The stabilizer is preferably HNO₃ or HClO₄. When HNO₃ is used as the stabilizer, the concentration thereof is preferably greater than 0.1% but no greater than 70%, more preferably 1.0% to 60%, yet more preferably 5% to 50%, and most preferably 10% to 20%. When HClO₄ is used as the stabilizer, the concentration thereof is preferably greater than 0.1% but no greater than 60%, more preferably 1.0% to 50%, and yet more preferably 5% to 40%. Sulfuric acid is not desirable as the stabilizer since it makes an (NH₄)₂Ce(NO₃)₆ etching liquid cloudy. In the etching liquid employing (NH₄)₂Ce(NO₃)₆ of the present invention, it is preferable for the stabilizer to have a concentration in the above-mentioned range since the etching liquid has improved stability.

When Ce(SO₄)₂ is used in the present invention, from the viewpoint of the treatment capability of the etching liquid, it is at least 0.5%, and preferably at least 1.0%, and although the treatment speed increases as the concentration increases, from the viewpoint of solubility it is no greater than 30%, preferably no greater than 25%, more preferably 2.0% to 25%, and yet more preferably 5% to 15%. In the etching liquid employing Ce(SO₄)₂, it is preferable for the concentration to be in the above-mentioned range since the etching capability is excellent.

In the etching liquid of the present invention employing Ce(SO₄)₂, in order to prevent degradation of the etching capability of Ce(SO₄)₂, a stabilizer may be used, and it is preferable for the etching liquid to comprise a stabilizer. The stabilizer is preferably HNO₃ or H₂SO₄, and more preferably HNO₃. When HNO₃ is used as the stabilizer, the concentration thereof is preferably greater than 0.1% but no greater than 70%, more preferably 1.0% to 60%, and yet more preferably 5.0% to 50%. When H₂SO₄ is used as the stabilizer, the concentration thereof is greater than 0.1%, preferably at least 1.0%, more preferably at least 2.0%, and yet more preferably at least 5.0%; and it is preferably no greater than 40%, more preferably no greater than 30%, and yet more preferably no greater than 20%. In the etching liquid employing Ce(SO₄)₂, it is preferable for the stabilizer to have a concentration in the above-mentioned range since degradation of the etching capability of the etching liquid can be prevented.

When (NH₄)₄Ce(SO₄)₄ is used in the etching liquid, from the viewpoint of etching capacity the amount of (NH₄)₄Ce(SO₄)₄ added is greater than 0.5%, preferably at least 1.0%, more preferably at least 2.0%, and yet more preferably at least 5.0%; the processing speed increases with concentration, but from the viewpoint of solubility it is no greater than 30%, preferably no greater than 25%, and more preferably no greater than 15%. In the etching liquid employing (NH₄)₄Ce(SO₄)₄ the etching capacity is excellent when the concentration is in the above-mentioned range.

In the etching liquid comprising (NH₄)₄Ce(SO₄)₄, in order to prevent decomposition of the etching liquid, a stabilizer may be used, and in this etching liquid it is preferable to add a stabilizer. When H₂SO₄ or HClO₄ is used as the stabilizer, the concentration thereof is preferably greater than 1.0% and preferably no greater than 40%, more preferably 2.0% to 30%, and yet more preferably 3% to 20%. Nitric acid is not desirable as a stabilizer since the (NH₄)₄Ce(SO₄)₄ etching liquid becomes cloudy. In the etching liquid employing (NH₄)₄Ce(SO₄)₄ the stability of the etching liquid improves when the concentration of the stabilizer is in the above-mentioned range.

The etching liquid of the present invention may employ Ce(NO₃)₄. The amount of Ce(NO₃)₄ used is at least 0.5% but no greater than 30%, and preferably 5.0% to 20%.

When Ce(NO₃)₄ is used, it is preferable to synthesize it immediately before it is used in the etching liquid. As a method for synthesizing Ce(NO₃)₄, a known method may be employed for the synthesis, and examples thereof include a method in which cerium hydroxide and nitric acid are added to ion exchanged water and heated. When Ce(NO₃)₄ is used, it is preferable to use HNO₃ as the stabilizer.

Needless to say, when the first etching liquid of the present invention comprises a stabilizer, the solubility of the etching liquid comprising (NH₄)₂Ce(NO₃)₆, Ce(SO₄)₂, or Ce(NO₃)₄ changes depending on the type of stabilizer, the temperature of the solution, the pH of the solution, the polarity of the solution, the common-ion effect, etc. When for example (NH₄)₂Ce(NO₃)₆ is used, the solubility might become 70% or less depending on the above-mentioned various conditions. In this case, the amount of (NH₄)₂Ce(NO₃)₆ used in the etching liquid of the present invention is greater than 0.1 wt % and no greater than an amount that gives a saturation concentration, and the same applies to Ce(SO₄)₂ or Ce(NO₃)₄.

As one example of the solubility, the saturation concentration of (NH₄)₂Ce(NO₃)₆ at each temperature when an HNO₃ aqueous solution was used was measured. The results are shown in Tables 1 and 2 below.

TABLE 1

| HNO₃ | Solubility of |
|---|---|
| concentration | (NH₄)₂Ce(NO₃)₆ |
| (wt %) | at 25° C. (wt %) |
| 0 | 59.51 |
| 5.51 | 43.00 |
| 9.98 | 35.20 |
| 12.83 | 31.31 |
| 19.16 | 24.12 |
| 30.02 | 15.50 |
| 48.81 | 6.69 |
| 62.43 | 4.50 |
| 73.02 | 3.13 |
| 80.01 | 2.71 |
| 88.95 | 2.60 |

TABLE 2

| HNO₃ | Solubility of |
|---|---|
| concentration | (NH₄)₂Ce(NO₃)₆ |
| (wt %) | at 50° C. (wt %) |
| 0 | 65.55 |
| 6.48 | 47.51 |
| 9.98 | 40.49 |
| 14.89 | 32.84 |
| 24.39 | 22.51 |
| 31.31 | 17.69 |
| 42.52 | 12.11 |
| 61.31 | 5.26 |
| 80.01 | 4.30 |

The liquid temperature at the time of etching in the etching step is preferably 10° C. to 70° C., more preferably 20° C. to 60° C., and yet more preferably 30° C. to 50° C. When the liquid temperature is in the above-mentioned range, the etching capacity is excellent.

The etching time in the etching step is not particularly limited, but is preferably 0.2 to 30 minutes, more preferably 0.3 to 25 minutes, and yet more preferably 0.4 to 15 minutes. When the etching time is in the above-mentioned range, there is little damage to a substrate, etc. in the etching process.

Furthermore, it is preferable to regulate the length of the etching time in the etching step according to the results obtained in an analysis step, which is described later.

A etching method time in the etching step is not particularly limited and may be used, for example, an immersing method or a spraying method.

When a conductive polymer is patterned by etching using the etching liquid of the present invention, it is necessary to use a photoresist for protecting a section in which the conductive polymer is not dissolved by the etching liquid. With regard to the photoresist, there are a positive type in which a section that has been irradiated with UV rays is dissolved by a developer, and a negative type in which a section that has been irradiated with UV rays becomes insoluble in a developer.

For the positive type, many liquid resists exist, and it is used in etching with a line width of on the order of a few μm for, for example, a display such as an LCD (Liquid Crystal Display).

For the negative type, many dry film resists exist, and it is used in etching with a line width of on the order of a few tens of μm for, for example, a display such as a PDP (Plasma Display Panel).

Both the positive type resist and the negative type resist can be used in the present invention, and the positive type and the negative type may be selected according to the degree of definition of an intended pattern.

As a photoresist, a resist that can be removed using an alkali is preferable, and a liquid resist is more preferable.

The substrate is not particularly limited and may be selected according to an intended application; specific examples thereof include glass, quartz, polyester (e.g. polyethylene terephthalate, polyethylene naphthalate, etc.), polyolefin (e.g. polyethylene, polypropylene, polystyrene, etc.), polyimide, polyacrylate, and polymethacrylate. Furthermore, it is particularly effective when the substrate is a substrate having transparency (a transparent substrate).

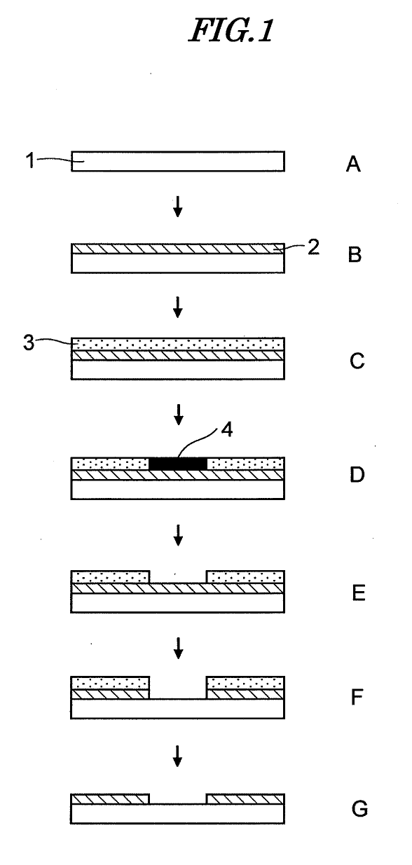

One example of the method for patterning a conductive polymer is explained by reference to FIG. 1.

FIG. 1A to FIG. 1G are schematic process drawings of one example in which a conductive polymer is etched by using the etching liquid of the present invention, thus giving a circuit pattern of the conductive polymer.

As an example of application of the etching liquid of the present invention, the top of a transparent substrate 1 (FIG. 1A) is coated with a conductive polymer 2 (FIG. 1B), a resist 3 (FIG. 1C) is applied (FIG. 1C) over the transparent substrate 1 (FIG. 1B), and exposure is carried out in accordance with a circuit diagram (FIG. 1D). The resist in the exposed section is removed by a developer, and the conductive polymer film is exposed (FIG. 1E). The conductive polymer film is patterned by etching the developed substrate using the etching liquid of the present invention (FIG. 1F). Subsequently, by washing and removing the remaining resist section the substrate with the conductive polymer film thus patterned is obtained (FIG. 1G). The conductive polymer layer preferably has a film thickness of 10 to 100 nm.

In FIG. 1, as the resist 3 a positive resist is used, but the present invention is not limited thereto, and a negative resist may be used.

### (Analysis Step)

The etching method of the present invention comprises an analysis step of analyzing the etching liquid by analysis means such as, for example, oxidation-reduction potential measurement, oxidation-reduction titration, and electrical conductivity measurement.

Examples of the analysis means include oxidation-reduction potential measurement, oxidation-reduction titration, electrical conductivity measurement, absorbance measurement, colorimetric measurement, measurement of amount etched, and etching speed measurement. Among them, the analysis means is preferably at least one selected from the group consisting of oxidation-reduction potential measurement, oxidation-reduction titration, electrical conductivity measurement, and absorbance measurement, it is more preferably at least one selected from the group consisting of oxidation-reduction potential measurement, oxidation-reduction titration, and electrical conductivity measurement, it is yet more preferable to carry out analysis by means of at least oxidation-reduction potential measurement or oxidation-reduction titration, and it is particularly preferable to carry out analysis by means of at least oxidation-reduction potential measurement.

When the etching liquid comprising a specific cerium (IV) compound is used, the Ce⁴⁺ concentration as an oxidizing agent in the liquid decreases accordingly, and in the etching method of the present invention it is preferable to analyze the Ce⁴⁺ concentration and carry out control of the etching liquid according to the analysis result.

Preferred examples of means of determining the amount of decrease of Ce⁴⁺ in the etching liquid include oxidation-reduction titration and/or oxidation-reduction potential measurement of the etching liquid.

Furthermore, the degree of exhaustion of the etching liquid, that is, the amount of conductive polymer that can be etched by the current etching liquid, may be judged by the electrical conductivity of the etching liquid. Electrical conductivity is an indicator for the amount of ions present in a liquid. In the present invention, it is thought that change in the amount of nitrate ions is the main factor for the change in electrical conductivity, but details are not clear.

Moreover, judging the degree of exhaustion of the etching liquid by change in color of the etching liquid is also preferred means. That is, preferred methods include measurement of the absorbance of the etching liquid and a method (colorimetric measurement) in which a color chart, etc. is prepared and comparison therewith is made.

Other than the above, determination may be carried out using means of measuring the amount etched of conductive polymer that is to be etched or means of measuring the speed of etching of a conductive polymer by an etching liquid.

The amount of decrease of Ce⁴⁺ may be measured directly by measuring the concentration of Ce⁴⁺, which is the oxidizing agent in the etching liquid comprising a specific cerium (IV) compound, but the amount of decrease of Ce⁴⁺ may also be determined by measuring Ce³⁺ concentration since the increase in Ce³⁺ is the same as the amount of decrease of Ge⁴⁺.

The amount of decrease of Ce⁴⁺ in the etching liquid may be determined by measuring, for example, the oxidation-reduction potential of the etching liquid. That is, when the oxidation-reduction potential of the etching liquid is measured, it is confirmed that the oxidation-reduction potential can be fitted to the Ce⁴⁺ and Ce³⁺ ratio, and the amount of decrease of Ce⁴⁺ can therefore be determined by measuring the oxidation-reduction potential if the total Ce concentration is known.

The reversible oxidation-reduction potential of the reaction Ce⁴⁺+e⁻→Ce³⁺ is expressed as follows.

E=E⁰+(RT/nF)ln [(Ce⁴⁺)/(Ce³⁺)]

E=E⁰+0.059×log [(Ce⁴⁺)/(Ce³⁺)]

The total Ce concentration can be estimated from the amount of Ce initially charged and the amount of Ce supplied. E⁰ is determined from a published value or by actual measurement of oxidation-reduction potential at [Ce⁴⁺]=[Ce³⁺]. When the oxidation-reduction potential E of the etching liquid is actually measured, the amount of Ce³⁺ formed is determined, and the amount of decrease of Ce⁴⁺ is obtained.

Furthermore, the etching speed corresponds to the Ce⁴⁺ concentration in the etching liquid, and when the concentration decreases the etching speed slows down. Since the speed can be maintained constant by keeping the Ce⁴⁺ concentration in the etching liquid in a fixed range, it is also possible to carry out control of the etching liquid by measuring the etching speed and supplying Ce⁴⁺ so as to make the speed constant. With regard to measurement of the speed of etching, the time required for etching may be determined by shining light on a substrate, etc. that is to be subjected to the etching process and measuring the amount of light transmitted, and the speed of etching can be determined from the value.

With regard to the above-mentioned means of determining the amount of decrease of Ce⁴⁺ in the etching liquid, one means may be used on its own or two or more means may be used in combination.

Oxidation-reduction potential (OPR) measurement enables monitoring to be carried out simply and continuously and is means that has excellent precision. Oxidation-reduction titration is means having excellent precision. Electrical conductivity (EC) measurement enables monitoring to be carried out simply and continuously and is means having high reproducibility for analysis values.

Furthermore, oxidation-reduction titration is preferably oxidation-reduction titration employing potassium iodide since it is not influenced by organic substances such as a conductive polymer or its decomposition products.

Specifically, dissolved tetravalent cerium may be quantitatively determined by making potassium iodide act on the etching liquid and subjecting the released iodine to a reduction titration method using sodium thiosulfate.

Furthermore, in the analysis step, it is preferable to carry out analysis by using in combination oxidation-reduction potential (OPR) measurement and electrical conductivity (EC) measurement. The ORP measurement is greatly affected by the ratio of tetravalent cerium (Ce⁴⁺) and trivalent cerium (Ce³⁺) present, whereas the EC measurement is greatly affected also by nitric acid or other molecular species. Therefore, in accordance with the combined use of ORP measurement and EC measurement, when the change in EC is different from usual, or the change in ORP and the change in EC are greatly different from each other, it can be considered that there is some abnormality (for example, the nitric acid concentration has decreased to a great extent), and this makes it possible to carry out control of the etching liquid more stably.

Furthermore, in the analysis step, there is no particular restriction on the analysis target, and needless to say analysis of various factors of the etching liquid or analysis of an etched subject such as a conductive polymer or a substrate may be carried out. For example, by carrying out not only analysis of Ce⁴⁺ concentration but also analysis of etching from various viewpoints, it becomes possible to carry out control of the etching liquid more stably and, furthermore, control the overall etching method more stably.

### (Control Step)

The etching method of the present invention comprises a control step of carrying out control of the etching step according to the result obtained in the analysis step.

In the control step, according to the result of the Ce⁴⁺ concentration, etc. obtained in the analysis step, control of the etching step may be carried out by various means. The means are not particularly limited, but it is preferable to carry out control using at least one means among means (1) to (4) shown below.

(1) Means of replenishing with at least one type of specific cerium (IV) compound
(2) Means of replenishing with fresh etching liquid
(3) Means of replacing part or the entirety of the etching liquid
(4) Means of regulating the etching time or the etching temperature

As the means (1) of replenishing at least one type of specific cerium (IV) compound, there can be cited as an example means of adding a specific cerium (IV) compound in the form of a solid directly to the etching liquid and/or means of oxidizing Ce³⁺ to Ce⁴⁺.

When a specific cerium (IV) compound is added in the form of a solid directly to the etching liquid, it is preferable to be able to stir the etching liquid.

Examples of the specific cerium (IV) compound include (NH₄)₂Ce(NO₃)₆, Ce(SO₄)₂, Ce(NO₃)₄, and (NH₄)₄Ce(SO₄)₄, which are described above. Among them, it is preferable to replenish with (NH₄)₂Ce(NO₃)₆ (ceric ammonium nitrate).

As the means of oxidizing Ce³⁺ to Ce⁴⁺, there can be cited as an example means of electrically oxidizing or means of oxidizing using an oxidizing agent. With regard to electrodes in the means of electrically oxidizing and the oxidizing agent in the means of oxidizing using an oxidizing agent, known materials may be used.

As the means (2) of replenishing with fresh etching liquid, there can be cited as a preferred example means of adding a solution containing a specific cerium (IV) compound (replenisher) to the etching liquid.

The solution in the means of adding a solution containing a specific cerium (IV) compound to the etching liquid may be a solution containing only a specific cerium (IV) compound or a solution containing not only a specific cerium (IV) compound but also another component such as an acid. Furthermore, needless to say, even when a solution containing only a specific cerium (IV) compound is added, a solution containing another component such as an acid may be added separately.

From the viewpoint of stability of the etching liquid, regardless of the method for adding a specific cerium (IV) compound or whether or not there is addition, it is preferable to carry out control of the concentration of the stabilizer. As a method for carrying out control, a known method may be used.

The concentration of the solution containing a specific cerium (IV) compound in the means of adding a solution containing a specific cerium (IV) compound to the etching liquid is not particularly limited, but from the viewpoint of the volume of etching equipment it is preferably the same as the concentration of the etching liquid before etching of a conductive polymer is carried out (initial concentration) or higher than the initial concentration of the etching liquid, and is more preferably higher than the initial concentration of the etching liquid.

The means of replenishing with fresh etching liquid is particularly preferably means of replenishing with a ceric ammonium nitrate solution as a replenisher.

Furthermore, a component, other than the specific cerium (IV) compound, that the etching liquid may contain may be added to the etching liquid.

For example, in order to maintain a constant concentration of an acid in the etching liquid, it is preferable to add an acid such as for example nitric acid or sulfuric acid or a solution thereof.

Moreover, when being supplied to the etching liquid, it is not always necessary to supply the components as one liquid in which they are mixed, and they may be supplied separately as a plurality of solutions. Furthermore, a method for supplying to the etching liquid is not particularly limited, and addition may be carried out at once, continuously, or intermittently.

When (3) part or the entirety of etching liquid is replaced, it may be judged depending on the results obtained in the analysis step how much a part of the etching liquid is replaced or whether the entirety of the etching liquid is replaced. Furthermore, the timing for replacing the etching liquid may be judged depending on the results obtained in the analysis step.

When the entirety of the etching liquid is replaced, it is preferable to wash an etching vessel for carrying out etching. A method for washing is not particularly limited, and preferred examples include washing with water and/or washing with the etching liquid. As necessary, it may be washed with an organic solvent, or when a salt is formed in the etching vessel the salt may be removed.

Such replacement operation or washing operation may be carried out automatically by incorporating automated equipment into the equipment, or may be carried out manually by a user.

As the means (4) of regulating the etching time or the etching temperature, according to the results obtained in the analysis step, for example, when the Ce⁴⁺ concentration in the etching liquid is low, the time for carrying out etching is made longer than usual and/or the etching temperature is made higher than usual, and when the Ce⁴⁺ concentration is high, the time for carrying out etching is made shorter than usual and/or the etching temperature is made lower than usual. Furthermore, regulation of the etching time or the etching temperature may be carried out not only with respect to the Ce⁴⁺ concentration in the etching liquid but also with respect to the current temperature of the etching liquid, the Ce³⁺ concentration (total cerium concentration), the amount of materials contained in the etching liquid such as the amount of conductive polymer etched, or physical properties.

In the control step, it is preferable to control the Ce⁴⁺ concentration in the etching liquid so that it is an optimum value, but in the actual control operation it is carried out over a concentration range that includes the optimum value. The upper limit of the Ce⁴⁺ concentration is usually a value at which etching is too fast and control of etching is impossible, and the lower limit is determined by a value at which etching does not progress, but in reality the concentration range is determined while taking into consideration the economic efficiency as well.

Furthermore, in the control step, it is preferable to carry out the means (1) or (2) above when the content of the specific cerium (IV) compound in the etching liquid becomes less than the concentration range described in the etching step, more preferably less than 1.0%, yet more preferably less than 2.0%, and particularly preferably less than 5.0%.

Moreover, it is preferable to supply fresh etching liquid or etching liquid constituent components to the etching liquid in an amount corresponding to the amount of etching liquid discharged outside the system by being carried by a substrate that has been subjected to the etching process, thus maintaining the amount of etching liquid at a constant level, since the etching process can be carried out more stably.

Furthermore, the control in the control step may be carried out not only by control of the Ce⁴⁺ concentration in the etching liquid but also, needless to say, by control with respect to a factor other than the Ce⁴⁺ concentration of the etching liquid or control with respect to an etched material such as a conductive polymer or a substrate. By carrying out not only control of the Ce⁴⁺ concentration, which is cited above as an example, but also control related to etching with respect to another component of the etching liquid (acid concentration, total amount of cerium, amount of decomposition product of conductive polymer, etc.), it becomes possible to carry out control of the etching liquid more stably and control of the entire etching method more stably.

Equipment for carrying out the etching method of the present invention is not particularly limited as long as the etching method of the present invention can be carried out, and it is preferably etching liquid control equipment that comprises equipment for supplying an etching liquid to etching equipment equipped with an etching vessel or an etching diffuser in order to maintain the Ce⁴⁺ concentration of the etching liquid in a predetermined range, this supply equipment being provided with equipment for detecting Ce⁴⁺ concentration in the etching liquid, and the supply equipment being operated based on the detection result.

The control step may be carried out by controlling by computer, etc. the results obtained in the respective measurement equipment in the analysis step, or a user may be informed of the results and the control step may be carried out by the user.

As equipment for detecting Ce⁴⁺ concentration that the control equipment is provided with, it is determined according to detection means, and specific examples thereof include equipment for measuring oxidation-reduction potential, equipment for carrying out oxidation-reduction titration, and equipment for measuring an electrical conductivity. Such methods and equipment for carrying out oxidation-reduction potential measurement, oxidation-reduction titration, and electrical conductivity measurement may be referred to in, for example, ‘Bunseki Kagaku Binran Revised 5^{th} Edition’ (Analytical Chemistry Handbook), Ed. by The Japan Society of Analytical Chemistry, 2001, Maruzen, etc.

Furthermore, equipment for measuring the etching speed of a substrate may also be used. As equipment for detecting the amount of substrate etched, equipment that detects the number of substrates that have been subjected to an etching process can be cited.

The substrate having a conductive polymer of the present invention is a substrate having a conductive polymer that has been etched by the etching method of the present invention, and is effective when it is a transparent substrate having a conductive polymer that has been etched by the etching method of the present invention.

The etching method of the present invention may be applied to etching of a conductive polymer that is used in an electrolytic capacitor, a battery, a touch panel, a liquid crystal panel, electronic paper, lighting using an organic EL, an organic EL device, etc.

Therefore, promotion of use of a conductive polymer can be expected in applications where etching is required such as patterning of a conductive polymer in a display pixel area of displays represented by a polymer organic EL display and a connection area between a peripheral circuit and the conductive polymer, patterning of a conductive polymer in a detection area of a touch panel and a connection area between a peripheral circuit and the conductive polymer, and removal of conductive polymer attached to an unwanted area at the time of production of a capacitor.

Moreover, the substrate having a conductive polymer of the present invention may be suitably used in an electrolytic capacitor, a battery, a touch panel, a liquid crystal panel, electronic paper, lighting using an organic EL, an organic EL device, etc.

### EXAMPLES

The present invention is explained below by reference to Examples, but the present invention should not be construed as being limited to these Examples.

### Example 1

Predetermined amounts of ceric ammonium nitrate ((NH₄)₂Ce(NO₃)₆ (hereinafter, also called ‘CAN’)) and conc. nitric acid were added to water at the ratio shown in Table 3, thus preparing etching liquid 1.

Separately, a film of a polythiophene-based conductive polymer (Baytron PH 500, H C Starck) was formed on the surface of a 2.5×5 cm rectangular polyethylene terephthalate (PET) sheet so that the weight of the conductive polymer was 100 mg, and subjected to an etching test.

The conductive polymer test piece thus formed was immersed in 100 g of the etching liquid and dissolved by stirring at room temperature for 27 hours.

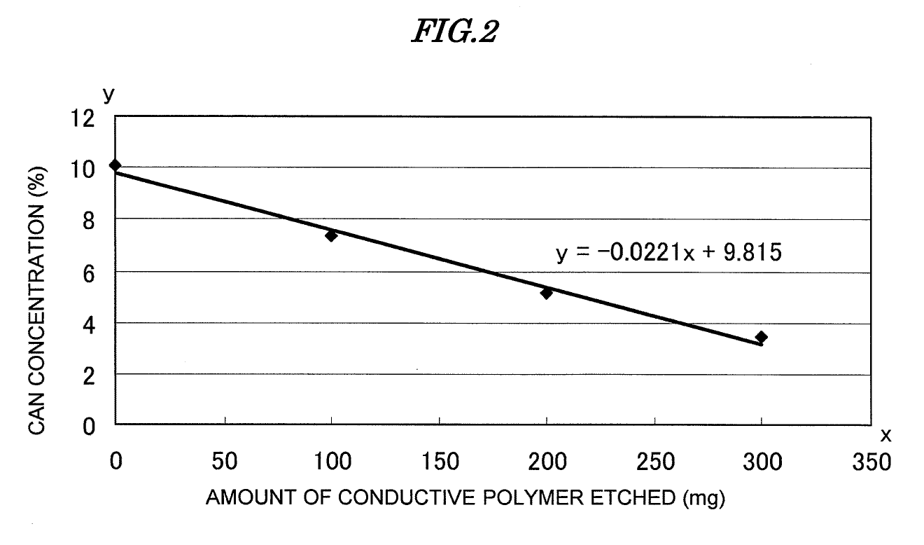

Subsequently, the CAN concentration was determined by a titration method using potassium iodide (oxidation-reduction titrimetry). The results are shown in Table 4 and FIG. 2.

From the results, it was confirmed that, as the amount of conductive polymer etched increased, the CAN concentration decreased. From this, it has been found that control of the etching liquid is possible by determining the CAN concentration of the etching liquid by means of oxidation-reduction titration.

In FIG. 2, the amount of conductive polymer when the CAN concentration became 0, from a fitting equation, was 444 mg per 100 g of etching liquid 1.

TABLE 3

Etching liquid composition

| | CAN | Nitric acid |
|---|---|---|
| Etching liquid | concentration (%) | concentration (%) |
| 1 | 10 | 15 |
| 2 | 5 | 10 |

TABLE 4

| | Amount of | Amount of conductive | CAN |
|---|---|---|---|
| Etching | etching | polymer etched | concentration |
| liquid | liquid (g) | (mg) | (%) |
| 1 | 100 | 0 | 10.05 |
| | 100 | 100 (1 sheet) | 7.38 |
| | 100 | 200 (2 sheets) | 5.16 |
| | 100 | 300 (3 sheets) | 3.44 |

### Example 2

Etching liquid 2 shown in Table 3 was prepared in the same manner as in Example 1. Furthermore, similarly, a film of a polythiophene-based conductive polymer (Baytron PH 500, H C Starck) was formed on the surface of a 2.5×5 cm rectangular PET sheet so that the weight of the conductive polymer was 50 mg, and subjected to an etching test. The conductive polymer was dissolved by the same method as in Example 1.

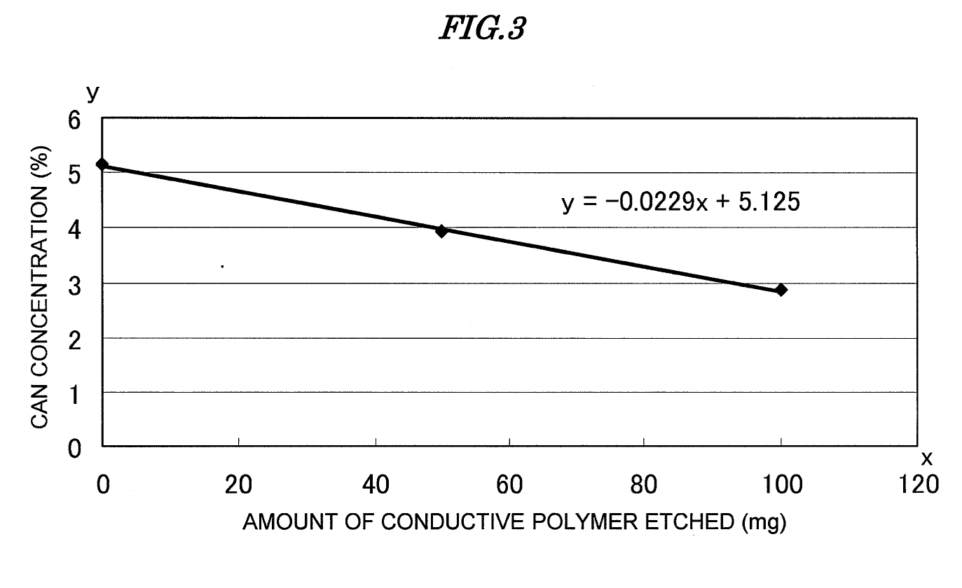

Subsequently, the CAN concentration was determined by a titration method using potassium iodide (oxidation-reduction titrimetry). The results are shown in Table 5 and FIG. 3.

From the results, it was confirmed that, as the amount of conductive polymer etched increased, the CAN concentration decreased even when the CAN concentration and the nitric acid concentration were changed.

TABLE 5

| | Amount of | Amount of conductive | CAN |
|---|---|---|---|
| Etching | etching | polymer etched | concentration |
| liquid | liquid (g) | (mg) | (%) |
| 2 | 100 | 0 | 5.15 |
| | 100 | 50 (1 sheet) | 3.93 |
| | 100 | 100 (2 sheets) | 2.86 |

### Example 3

Conductive polymer test pieces were immersed in 100 g of etching liquids 1 and 2 and dissolved by stirring at room temperature for 27 hours. Subsequently, the oxidation-reduction potential (ORP) was measured. The results are shown in Table 6.

From the results, it was confirmed that, as the amount of conductive polymer added increased, the ORP decreased. From this, it has been found that control of the etching liquid is possible by ORP.

TABLE 6

| | Amount of | Amount of conductive | Oxidation-reduction |
|---|---|---|---|
| Etching | etching | polymer etched | potential |
| liquid | liquid (g) | (mg) | (mV) |
| 1 | 100 | 0 | 1,513 |
| | 100 | 100 | 1,429 |
| | 100 | 200 | 1,417 |
| 2 | 100 | 0 | 1,518 |
| | 100 | 50 | 1,439 |
| | 100 | 100 | 1,421 |

### Example 4

34 mg of a conductive polymer (Baytron PH 500, H C Starck) was added to 130 g of etching liquid 1, and the ORP was measured over time. Subsequently, 108.8 mg, 164.2 mg, and 265.2 mg were added in the same manner, and the ORP was measured in the same manner. The total amount added up to that point was 572.2 mg. Since the value calculated from the equation obtained in Example 1 was 577 mg when the CAN concentration became 0, almost all of the CAN was consumed by etching.

After allowing to stand overnight, when a further 20 mg of the conductive polymer was added, the ORP decreased greatly. That is, it has been found that when the CAN concentration becomes substantially 0, the ORP decreases rapidly.

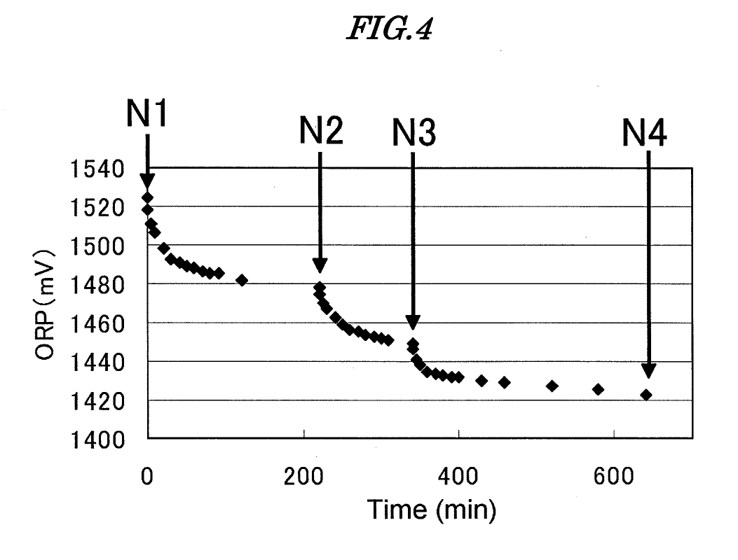

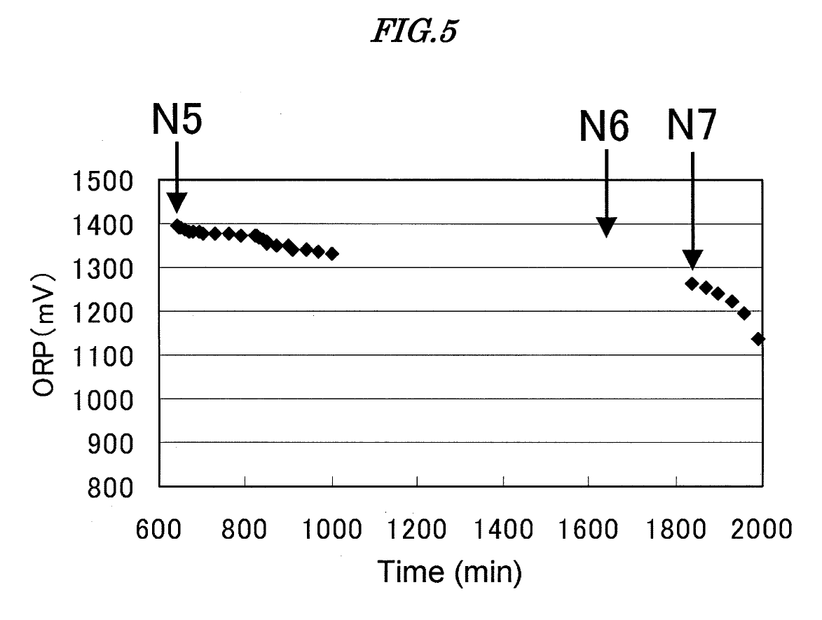

It has been found from this that the limit of etching capacity of the etching liquid can be determined by ORP measurement. Furthermore, it has been found that since the color of the liquid weakens from dark orange to yellow, it is possible to carry out control of the etching liquid and determine the limit of etching capacity by the use of absorbance measurement, a color chart, etc. ORP measurement data are shown in FIG. 4 and FIG. 5.

### Example 5

Conductive polymer test pieces were immersed in 100 g of etching liquids 1 and 2 and completely dissolved by stirring at room temperature for 27 hours.

Subsequently, electrical conductivity (EC) was measured. The results are shown in Table 7.

From the results, it was confirmed that, as the amount of conductive polymer added increased, the EC decreased. From this, it has been found that control of the etching liquid is possible by EC.

TABLE 7

| | Amount of | Amount of conductive | Electrical |
|---|---|---|---|
| Etching | etching | polymer etched | conductivity |
| liquid | liquid (g) | (mg) | (mS/cm) |
| 1 | 100 | 0 | 519 |
| | 100 | 100 | 515 |
| | 100 | 200 | 513 |
| 2 | 100 | 0 | 438 |
| | 100 | 50 | 437 |
| | 100 | 100 | 434 |

### Example 6

An approximately 50 nm thin film of conductive polymer (Baytron PH 500, H C Starck) was formed on the surface of a PET sheet, thus giving a test substrate.

An ORDYL LF525 dry film resist (Tokyo Ohka Kogyo Co., Ltd.) was affixed to the test substrate using a laminator. The test substrate with the dry film resist affixed thereto was exposed to UV while putting a master pattern in intimate contact therewith using a frame type vacuum exposure unit. The exposed test substrate was developed by spraying a 1% Na₂CO₃ aqueous solution as a developer at a spray pressure of 1 MPa while regulating at 30° C.

The developed test substrate was washed with water and then immersed in 100 g of etching liquid 1 (liquid temperature 30° C.), thus carrying out etching for 1 minute.

Test substrate etching was repeated, and when the CAN concentration of the etching liquid became less than 5%, the etching time for each test substrate was changed to 5 minutes, and further test substrate etching was carried out.

Just before the CAN concentration of the etching liquid became less than 0.5%, etching was stopped, 50 g of an etching liquid having a CAN concentration of 20% (CAN concentration being twice that of etching liquid 1) was added, test substrate was again etched at a liquid temperature of 30° C. for 1 minute, and the test substrate was sufficiently etched.

Moreover, further etching may also be carried out by replacing the etching liquid with fresh etching liquid 1 just before the CAN concentration of the etching liquid becomes less than 0.5%, or when it becomes less than 0.5%.

In addition, the etched test substrate was immersed in a 3% NaOH aqueous solution for 2 minutes while regulating the liquid temperature at 30° C., thus stripping the dry film resist.

The test substrate from which the dry film resist had been stripped was washed with water and dried by blowing air thereonto, thus giving a substrate having a patterned conductive polymer.

1. An etching method comprising:
an etching step of etching a conductive polymer using an etching liquid comprising greater than 0.5 wt % but no greater than 70 wt % of (NH₄)₂Ce(NO₃)₆, at least 0.5 wt % but no greater than 30 wt % of Ce(SO₄)₂, or greater than 0.5 wt % but no greater than 30 wt % of (NH₄)₄Ce(SO₄)₄;
an analysis step of analyzing the etching liquid by at least one analysis means selected from the group consisting of oxidation-reduction potential measurement, oxidation-reduction titration, and electrical conductivity measurement; and
a control step of controlling the etching step according to the results obtained in the analysis step.

2. The etching method according to claim 1, wherein in the analysis step analysis is carried out by at least oxidation-reduction potential measurement or oxidation-reduction titration.

3. The etching method according to claim 1, wherein in the analysis step analysis is carried out by at least oxidation-reduction potential measurement.

4. The etching method according to claim 1, wherein in the control step the etching step is controlled by at least one control means selected from the group consisting of (1) means of replenishing with one or more types selected from the group consisting of (NH₄)₂Ce(NO₃)₆, Ce(SO₄)₂, and (NH₄)₄Ce(SO₄)₄, (2) means of replenishing with fresh etching liquid, (3) means of replacing with fresh etching liquid, and (4) means of regulating the etching time.

5. The etching method according to claim 1, wherein the conductive polymer is a polyacetylene, a polyparaphenylene, a polyparaphenylene vinylene, a polyphenylene, a polythienylene vinylene, a polyfluorene, a polyacene, a polyaniline, a polypyrrole, or a polythiophene.

6. The etching method according to claim 1, wherein the conductive polymer is a polyaniline, a polypyrrole, or a polythiophene.

7. The etching method according to claim 1, wherein the conductive polymer is poly(3,4-ethylenedioxythiophene).

8. The etching method according to claim 1, wherein the etching liquid comprises (NH₄)₂Ce(NO₃)₆.

9. (canceled)

10. The etching method according to claim 1, wherein in the analysis step analysis is carried out by at least oxidation-reduction potential measurement, and the conductive polymer is a polyaniline, a polypyrrole, or a polythiophene.

11. The etching method according to claim 1, wherein in the analysis step analysis is carried out by at least oxidation-reduction potential measurement, the conductive polymer is poly(3,4-ethylenedioxythiophene), and the etching liquid comprises (NH₄)₂Ce(NO₃)₆.

12. The etching method according to claim 1, wherein in the analysis step analysis is carried out by at least oxidation-reduction potential measurement and electrical conductivity measurement.
